(19) United States
(12) Patent Application Publication
(10) Pub. No.: US 2011/0049206 A1
(43) Pub. Date: Mar. 3, 2011

(54) TIE-ABLE SECURING DEVICE FOR BICYCLE

(76) Inventors: Su-Chang LIAO, Taichung City (TW); Di-Shun Liao, Taichung City (TW)

(21) Appl. No.: 12/552,291

(22) Filed: Sep. 2, 2009

(51) Int. Cl. B62J 11/00

(52) U.S. Cl. 224/463

(57) ABSTRACT

A tie-able securing device for a bicycle includes a body. A functional module is disposed on the body. A first belt and a second belt are respectively flexibly extending from the body. A first fastener and a second fastener are respectively extending from the body. Each of the first belt and the second belt is selectively and alternatively secured on the first fastener and the second fastener. The first belt and the second belt are alternatively bendably secured on the first fastener and the second fastener for adapting to tie the body on a bicycle.

### BACKGROUND OF THE INVENTION

1. Field of the Invention

The present invention relates to a tie-able securing device, and more particularly to a tie-able securing device for a bicycle.

2. Description of Related Art

Because of lack of the bright sunlight, the sight and visibility of a bicycle rider at night are noticeably weakened, thus, they eventually affect the rider to distinguish and monitor the traffic. Moreover, to depend merely on the reflective warning lights of the rack and the frame of the bicycle during the night ride is passive and ineffective. Hence, bicycle manufacturers have developed attachable warning lights to be mounted on bicycles. On the one hand, the mounted warning lights increase the illuminating degree so that the sight and visibility of night rides are reinforced; on the other hand, the safety of night rides is enhanced because the mounted warning lights actively achieve the goal of providing definite light sources to caution other vehicles.

A conventional warning light is shown in FIGS. 9 and 10. The conventional warning light includes a light body 1 having two light sources 10 aligned at the front end and a soft belt 11 extended from the back end to provide a warning light effect. At the end of the belt 11 consists a hole 111. The two light sources 10, the belt 11, and its concave track are on the same axial direction. The top of the light body 1 protrudes to form a fastening body 12 to fasten the hole 111 of the belt 11. To mount the light on the bicycle, the light body 1 is positioned on the tube of the bicycle frame, the belt 11 is circled around the frame, and a coil structure is formed with the fastening body 12. Thus, the light body 1 is firmly tied on the bicycle.

A better illuminating method of the warning lights is to expand the light sources horizontally to the front. Therefore, a ray of a broad-wide illuminating area is formed in front of the bicycle so that the bicycle rider can monitor the road ahead and the nearby traffic condition. Normally the warning lights are secured on the flat tubes or the horizontal handlebars. The light body 1 is positioned directly at the top of the tube so that a broad-wide illuminating area in front of the bicycle is shaped. However, due to the structural design that the light sources 10 and the belt 11 are set in the same axial direction, the illuminating area will be changed from horizontal to vertical if the light body 1 is fixed on a vertical tube or on a side of a tube due to the curved handlebar tubes of a road bicycle or a racing bicycle. Though an illuminating area can still be formed in front of the bicycle, the level illuminating area is relatively reduced because the illuminating area has been changed from horizontal to longitudinal. Thus, the visibility of the road ahead and the nearby surroundings to the bicycle rider is greatly lowered.

In addition, the light body 1 has only one belt 11 and the fastening body 12 to fix to the top of the tube. Since the belt 11 has to support the weight of the light body 1, the caliber of the belt 11 is made rough and inelastic. If it is tied with a single circle on a tube having the diameter over 18 mm, it largely restricts the flexibility of warning light assembly. Besides, when traveling on a bumpy road, the light body 1 may be abruptly shifted due to the insufficient positioning force of the belt 11 and the fastening body 12 under continuous vibration of the bicycle frame. As a result, an accident may occur when the bicycle rider suddenly loses his control of the traffic.

Moreover, in addition to the warning lights being secured on the bicycle with a tie-able securing design, other peripheral gadgets such as meters, physical sensor devices, or GPS that facilitate riding functions or provide information are generally mounted on the bicycle with the tie-able securing design. When the design is poor, the gadgets can be easily fallen off from the bicycle because the securing system is not firm enough.

As mentioned above, the present tie-able securing design for warning lights or other peripheral gadgets not only limits the application of bicycle assembly which may affect the illuminating effect but also brings potential risk to a bicycle rider because of an unexpected fall-off or damage. Hence, an improvement of the design is crucial.

The present invention has arisen to mitigate and/or obviate the disadvantages of the conventional tie-able securing warning light device.

### SUMMARY OF THE INVENTION

The main objective of the present invention is to provide a tie-able securing device for a bicycle.

To achieve the objective, a tie-able securing device for a bicycle in accordance with the present invention comprises a body, a functional module mounted on the body, a first belt bendably extending from the body, a second belt bendably extending from the body, a first fastener extending from the body, and a second fastener extending from the body. The functional module includes a stopwatch, two ruminants, and a button for operating the stopwatch and the two ruminants. The functional module has a molding surface formed on the body. The body has two grooves defined in a surface thereof opposite to molding surface. The two grooves cross to each other. Each of the first belt and the second belt is positioned on a surface different from the molding surface. Each of the first fastener and the second fastener selectively corresponds to each of the first belt and the second belt. A distal end of each of the first belt and the second belt is alternatively secured on the first fastener and the second fastener. Each of the first belt and the second belt has an eyelet defined in a distal end thereof. Each of the first fastener and the second fastener has two bosses laterally protruding from a distal end thereof. The eyelet of each of the first belt and the second belt has an inner diameter being slightly greater than an outer diameter of each of the first fastener and the second fastener. A width of the two bosses including the first/second fastener is slightly greater than the inner diameter of the first/second belt. The first belt and the second belt are positioned on a same side of the body. The first fastener and the second fastener are positioned on another side of the body opposite to the first belt and the second belt.

In accordance with another aspect of the present invention, the first belt is positioned opposite to the second belt and the first fastener is positioned opposite to the second fastener. The first belt and the second belt can be alternatively secured on the first fastener and the second fastener for suiting different bicycle elements.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a tie-able securing device for a bicycle in accordance with the present invention;

FIG. 2 is a perspective view of the tie-able securing device for a bicycle in accordance with the present invention in another direction;

FIGS. 3-7 are operational views of the tie-able securing device for a bicycle in accordance with the present invention;

FIG. 8 is a perspective view of the tie-able securing device of a second embodiment in accordance with the present invention;

FIG. 9 is a perspective view of a conventional tie-able securing warning light device; and

FIG. 10 is an operational view of the conventional tie-able securing warning light device.

### DETAILED DESCRIPTION OF THE INVENTION

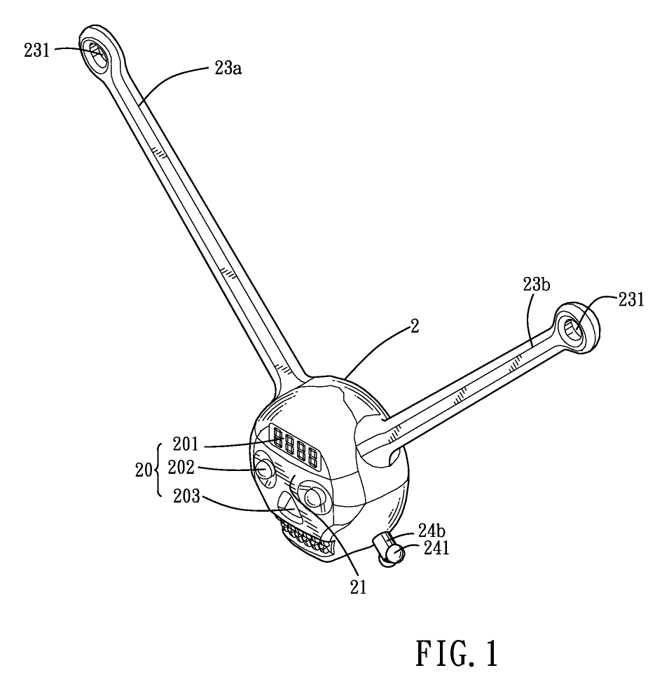

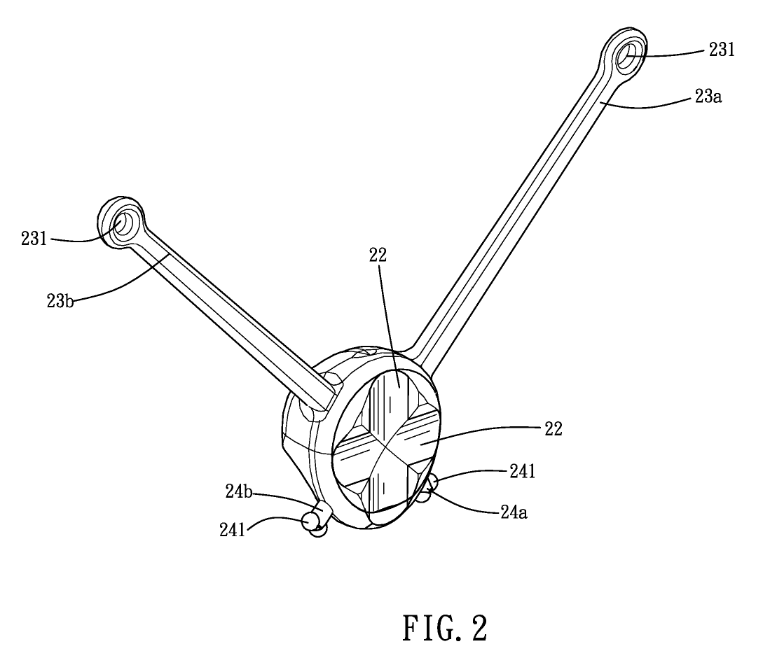

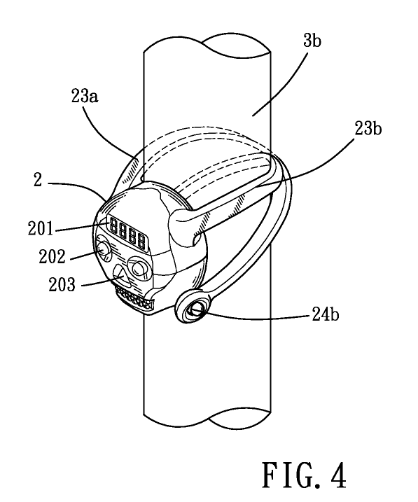

Referring to the drawings and initially to FIGS. 1-4, a tie-able securing device for a bicycle in accordance with the present invention comprises a body 2, a functional module 20 mounted on the body 2, a first belt 23a flexibly extending from the body 2, a second belt 23b flexibly extending from the body 2, a first fastener 24a extending from the body 2, and a second fastener 24b extending from the body 2.

The functional module 20 includes a stopwatch 201 (or an odometer), two ruminants 202, and a button 203 for operating the stopwatch 201 and the two ruminants 202. In the preferred embodiment of the present invention, the functional module 20 has a molding surface 21 formed on the body 2. The molding surface 21 is formed with a skull design. The stopwatch 201 is positioned on a forehead of the skull. The two ruminants 202 are respectively positioned on two eyes of the skull. The button 203 is positioned on a nose of the skull. The body 2 has two grooves 22 defined in a surface thereof opposite to molding surface 21. The two grooves 22 cross to each other.

Each of the first belt 23a and the second belt 23b is positioned on a surface different from the molding surface 21 such that the first belt 23a and the second belt 23b are staggered from the functional module 20. The first belt 23a and the second belt 23b are formed of soft material. Each of the first fastener 24a and the second fastener 24b selectively corresponds to each of the first belt 23a and the second belt 23b. A distal end of each of the first belt 23a and the second belt 23b is alternatively secured on the first fastener 24a and the second fastener 24b. Each of the first belt 23a and the second belt 23b has an eyelet 231 defined in a distal end thereof. Each of the first fastener 24a and the second fastener 24b has two bosses 241 laterally protruding from a distal end thereof. The eyelet 231 of each of the first belt 23a and the second belt 23b has an inner diameter being slightly greater than an outer diameter of each of the first fastener 24a and the second fastener 24b. A width of the two bosses 241 including the first/second fastener 24a/24b is slightly greater than the inner diameter of the eyelet 231 of the first/second belt 23a/23b to prevent the two bosses 241 of the first/second fastener 24a/24b detaching from the eyelet 231 of the first/second belt 23a/23b. In the preferred embodiment of the present invention, the first belt 23a and the second belt 23b are positioned on a same side of the body 2. The first fastener 24a and the second fastener 24b are positioned on another side of the body 2 opposite to the first belt 23a and the second belt 23b. When the two bosses 241 of the first/second fastener 24a/24b securely pass through the eyelet 231 of the first/second belt 23a/23b, the two bosses 241 of the first/second fastener 24a/24b are slightly struck in the eyelet 231 of the first/second belt 23a/23b for fixing the first/second belt 23a/23b on the first/second fastener 24a/24b to adapt to tie the body 2 on a bicycle.

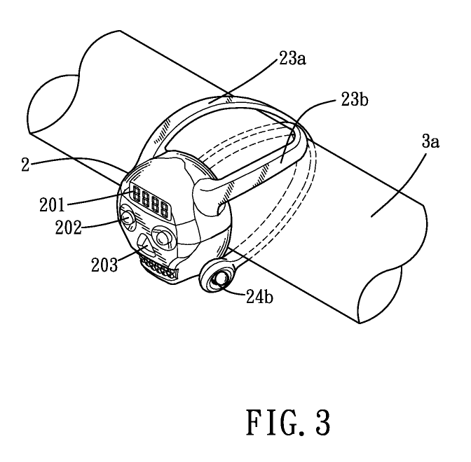

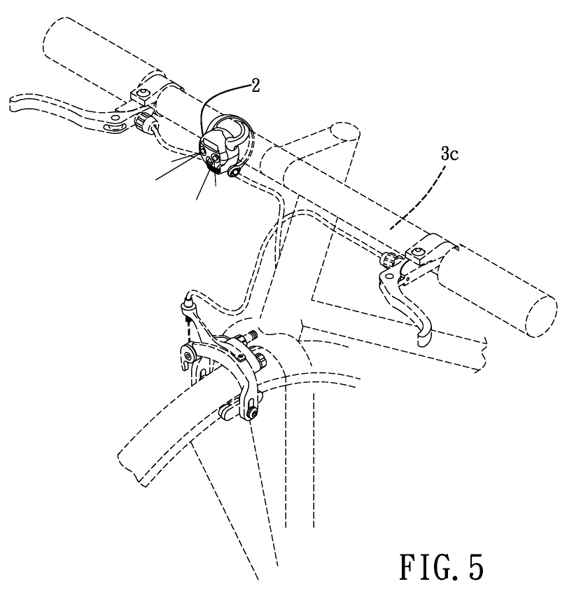

With reference to FIGS. 3-5, a vertical tube 3a and a horizontal tube 3b of a bicycle frame are alternatively, correspondingly, and partially received in the two crossed grooves 22 of the body 2. The two grooves 22 can also correspondingly suit to a curved handlebar (not shown) or a horizontal handlebar 3c of the bicycle. When assembling the body 2 on the tube 3a/3b, the tube 3a/3b is partially received in a corresponding groove 22. The first belt 23a and the second belt 23b are bended to encircle the tube 3a/3b. The bosses 241 of the first belt 23a are securely passed through the eyelet 231 of the first belt 23a and the bosses 241 of the second belt 23b are securely passed through the eyelet 231 of the second belt 23b such that the two belts 23a, 23b are crossed for tying the body 2 on the tube 3a/3b. The molding surface 21 is positioned frontward on the bicycle for providing a wide illuminated area.

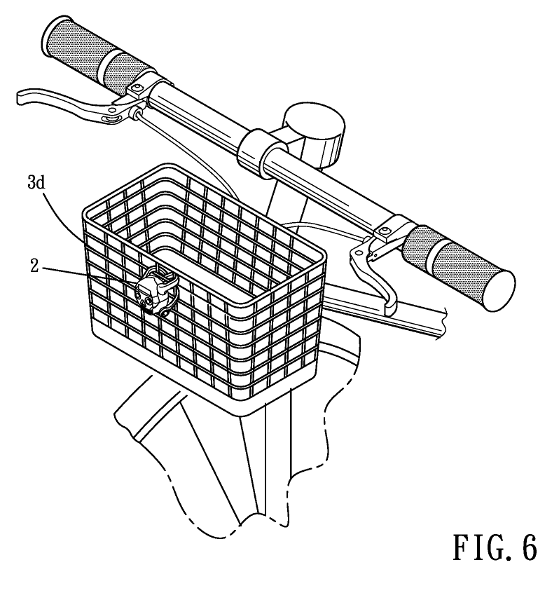

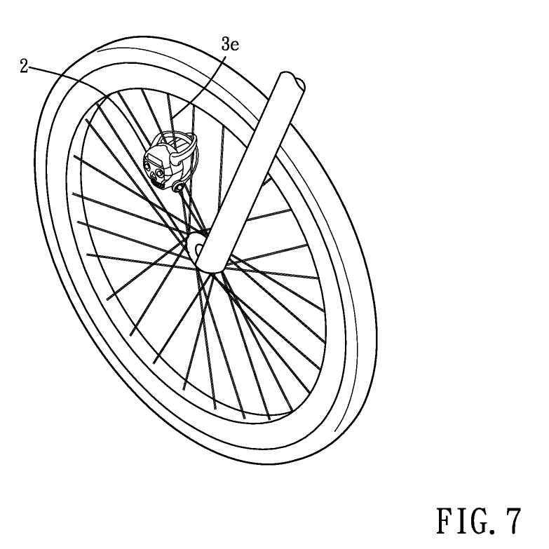

With reference to FIGS. 6-7, the first belt 23a and the second belt 23b are reiteratively crossly tied the body 2 such that a weight of the body 2 is supported by the first belt 23a and the second belt 23b. The two belts 23a, 23b have great ductility to tie the body 2 on a tube having an outer diameter less than 18 millimeters. The two belts 23a, 23b can be inserted into a bicycle basket 3d and tied the body 2 on the basket. The two belts 23a, 23b can be extended and repeatedly enclose multiple spokes 3e of the bicycle for tying the body 2 on a bicycle wheel. Therefore, the tie-able securing device according the present invention provides a great adaptability for suiting different bicycle elements.

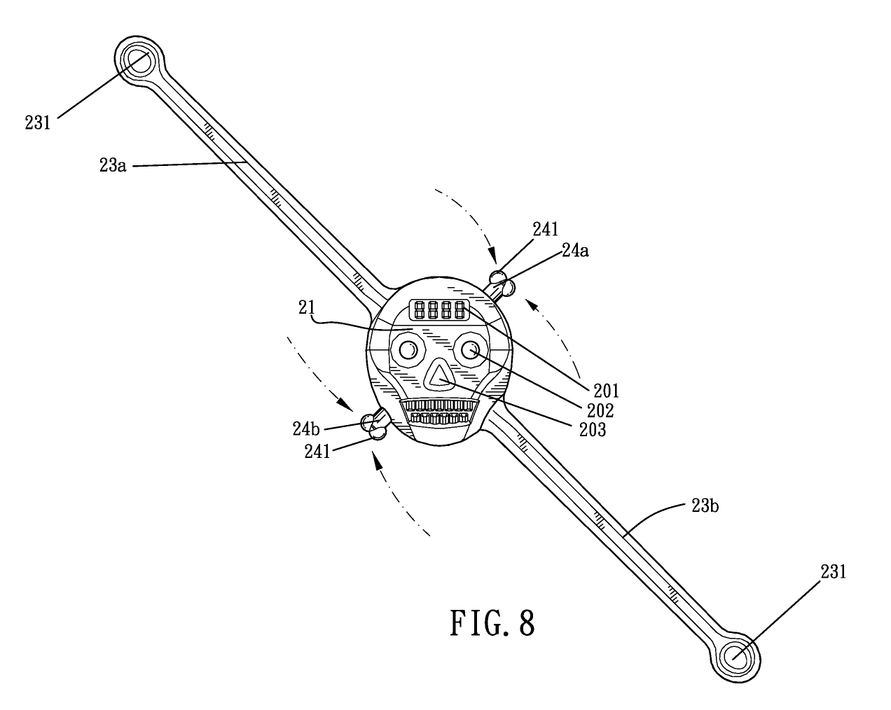

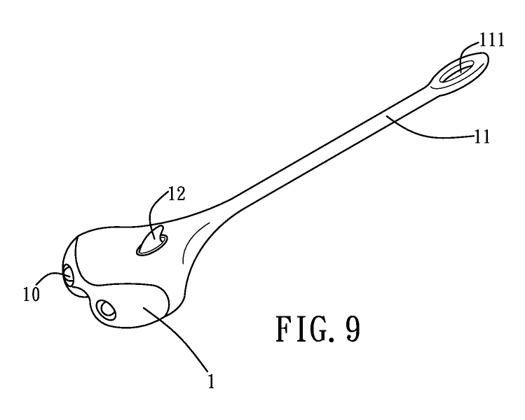

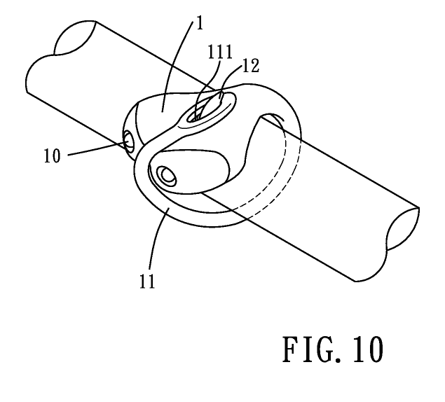

With reference to FIG. 8, that shows a second embodiment of the tie-able securing device for a bicycle in accordance with the present invention. The elements and effects of the third embodiment which are the same with the first embodiment are not described, only the differences are described. In the second embodiment of the present invention, the first belt 23a is positioned opposite to the second belt 23b and the first fastener 24a is positioned opposite to the second fastener 24b. In the preferred embodiment according to the present invention, the first belt 23a and the second belt 23b are aligned in a same phantom line. The first fastener 24a and the second fastener 24b are aligned in a same phantom line. The first belt 23a and the second belt 23b can be alternatively secured on the first fastener 24a and the second fastener 24b for suiting different bicycle element.

Although the invention has been explained in relation to its preferred embodiment, it is to be understood that many other possible modifications and variations can be made without departing from the spirit and scope of the invention as hereinafter claimed.

What is claimed is:

1. A tie-able securing device for a bicycle comprising:
a body;
a functional module disposed on the body; and
a first belt and a second belt respectively flexibly extending from the body, a first fastener and a second fastener respectively extending from the body, each of the first belt and the second belt selectively and alternatively secured on the first fastener and the second fastener;
wherein the first belt and the second belt are alternatively bendably secured on the first fastener and the second fastener for adapting to tie the body on a bicycle.

2. The tie-able securing device for a bicycle as claimed in claim 1, wherein the first belt, the second belt, the first fastener, and the second fastener are respectively positioned on surfaces of the body different from a surface of the functional module, the body having two grooves defined in a surface of the body opposite to the functional module, the two grooves crossing to each other.

3. The tie-able securing device for a bicycle as claimed in claim 1, wherein the functional module includes a stopwatch mounted on the body.

4. The tie-able securing device for a bicycle as claimed in claim 1, wherein the functional module includes an odometer mounted on the body.

5. The tie-able securing device for a bicycle as claimed in claim 1, wherein the functional module includes two ruminants mounted on the body.

6. The tie-able securing device for a bicycle as claimed in claim 1, wherein each of the first belt and the second belt has an eyelet defined in a distal end thereof, each of the first fastener and the second fastener having at least one boss laterally protruding from a distal end thereof, the at least one boss of the first fastener passing through the eyelet of the first belt and the at least one boss of the second fastener passing through the eyelet of the second belt for fixing the first belt on the first fastener and fixing the second belt on the second fastener, the eyelet of each of the first belt and the second belt having an inner diameter being slightly greater than an outer diameter of each of the first fastener and the second fastener.

7. The tie-able securing device for a bicycle as claimed in claim 1, wherein the first belt and the second belt are positioned on a same side of the body, the first fastener and the second fastener positioned on another side of the body opposite to the first belt and the second belt.

8. The tie-able securing device for a bicycle as claimed in claim 1, wherein the first belt is positioned opposite to the second belt, the first fastener positioned opposite to the second fastener.
